(19) United States
(12) Patent Application Publication
(10) Pub. No.: US 2006/0262346 A1
(43) Pub. Date: Nov. 23, 2006

(54) Image processing apparatus having a mechanism for backing up image data

(76) Inventor: Takashi Goto, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/409,077

(22) Filed: Apr. 24, 2006

(30) Foreign Application Priority Data
May 23, 2005 (JP) 2005-148980

(51) Int. Cl. G06F 3/12

(52) U.S. Cl. 358/1.15

(57) ABSTRACT

An image processing apparatus is disclosed. In the apparatus, image data are stored in an image storage unit, the image data in the image storage unit are transmitted to a specified server for backup when processing of the image data such as data transmission is completed successfully, and the processed image data in the image storage unit are deleted when the backup transmission is completed successfully. The apparatus includes a setting unit which sets conditions for retrying the backup transmission. The retry transmission of the processed image data is performed according to the retry conditions set by the setting unit when the backup transmission of the processed image data fails.

### BACKGROUND OF THE INVENTION

1. Field of the Invention

The present invention generally relates to an image processing apparatus, and particularly relates to an image processing apparatus which properly backs up processed image data.

2. Description of the Related Art

Some image processing apparatuses, such as facsimile apparatuses, incorporate a retransmission function which retransmits a document the transmission of which has failed, improving the reliability of transmission (refer to patent documents 1 and 2).

In addition, some facsimile apparatuses incorporate a backup function which saves the image data of transmitted documents as transmission history images onto an internal memory or a server connected to a network for reuse and other purposes, improving the availability of such apparatuses (refer to patent documents 3 and 4).

In facsimile apparatuses which incorporate such a conventional backup function, either all of the faxed image data (refer to patent document 3) or only the specified faxed image data are backed up (refer to patent document 4) after facsimile transmission.

[Patent document 1] Japanese Patent Application Publication No. 5-191618

[Patent document 2] Japanese Patent Application Publication No. 2004-32094

[Patent document 3] Japanese Patent Application Publication No. 2003-115971

[Patent document 4] Japanese Patent Application Publication No. 11-331454

In such facsimile apparatuses with the conventional backup function mentioned above, however, there has been a need for improvement to make backup transmission to the server more reliable.

The conventional backup technology mentioned above provides only the mechanism for sending the transmitted data to the server for backup, and no countermeasures are provided to cope with backup transmission errors which are caused by network problems or the installation environment. Therefore, there has been a need for improvement to make backups more reliable.

The improvement to make backups more reliable is needed not only in facsimile apparatuses but also in any other apparatuses which require backup transmission of image data that has gone through image processing such as data transmission.

### SUMMARY OF THE INVENTION

The present invention may provide an image processing apparatus that substantially obviates one or more problems caused by the limitations and disadvantages of the related art.

A preferred embodiment of the present invention may provide an image processing apparatus which more reliably backs up image data that has gone through image processing such as facsimile transmission and has good availability.

To achieve these and other advantages in accordance with the purpose of the invention, an image processing apparatus in which image data are stored in an image storage unit, the image data in the image storage unit are transmitted to a specified server for backup when the processing of the image data such as data transmission is completed successfully, and the processed image data in the image storage unit is deleted when the backup transmission is completed successfully, includes a setting unit for setting conditions for retrying the backup transmission, wherein the transmission of the processed image data is retried according to the retry conditions set by the setting unit when the backup transmission of the processed image data fails.

The image processing apparatus may incorporate a memory unit which stores plural methods for reporting the failure of all retry transmissions specified by the retry conditions, and a selecting unit for selecting one of the reporting methods in the memory unit, wherein a backup failure reporting process that reports backup failure is performed using the reporting method selected by the selecting unit when all of the retry transmissions fail.

Also, when the capacity of the image storage unit runs short because a new job involving storage of image data into the image storage unit is generated during the backup transmission or retry transmission of the processed image data in the image storage unit, the image processing apparatus may cancel the backup transmission or retry transmission, delete the processed image data from the image storage unit, and perform the backup failure reporting process.

In an image processing apparatus according to the present invention, when the backup transmission of image data, which image data have gone through image processing such as facsimile transmission or data transmission, to a specified server fails, the retry transmission of the processed image data is performed according to the specified retry conditions. This mechanism enables the retry transmission of the processed image data according to the retry conditions that suit the environment where the image processing apparatus is used, and enables more reliable backups of the processed image data, improving the availability.

### BRIEF DESCRIPTION OF THE DRAWINGS

FIG. 1 is a drawing showing the configuration of the main block of a facsimile apparatus which is an application of an embodiment of the image processing apparatus according to the present invention;

FIG. 2 is a table showing an example of the retry count and the retry interval for the backup transmission which are stored in the memory shown in FIG. 1;

FIG. 3 is a table showing an example of selectable backup transmission failure reporting methods in the facsimile apparatus shown in FIG. 1;

FIG. 4 is a table showing the forcible nondelivery setting which is stored in the memory shown in FIG. 1 and referred to during the backup transmission by the facsimile apparatus;

FIG. 5 is a table showing an example of the backup transmission destination information which is stored in the memory shown in FIG. 1 and referred to during the backup transmission by the facsimile apparatus;

FIG. 6 is a flowchart showing the backup transmission and retry transmission process in the facsimile apparatus shown in FIG. 1; and

FIG. 7 is a detailed flowchart of the nondelivery process shown in FIG. 6.

### DETAILED DESCRIPTION OF THE PREFERRED EMBODIMENTS

In the following, a preferred embodiment of the present invention is described in detail with reference to accompanying drawings. Since the embodiment described below is a best mode for carrying out the present invention, various limitations which are thought to be technically preferable are imposed. However, the scope of the present invention is not limited to the embodiment described below.

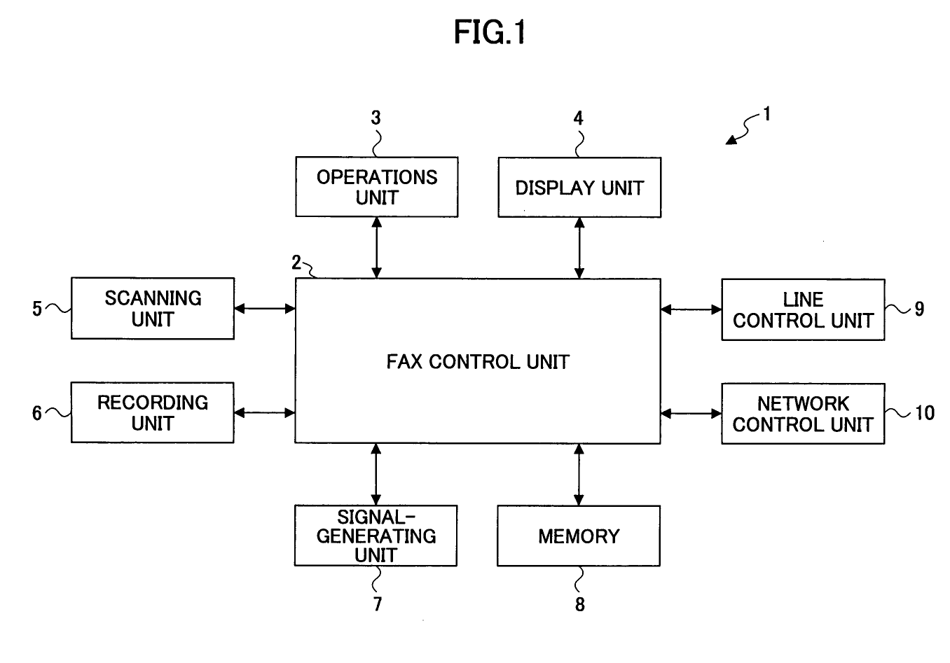

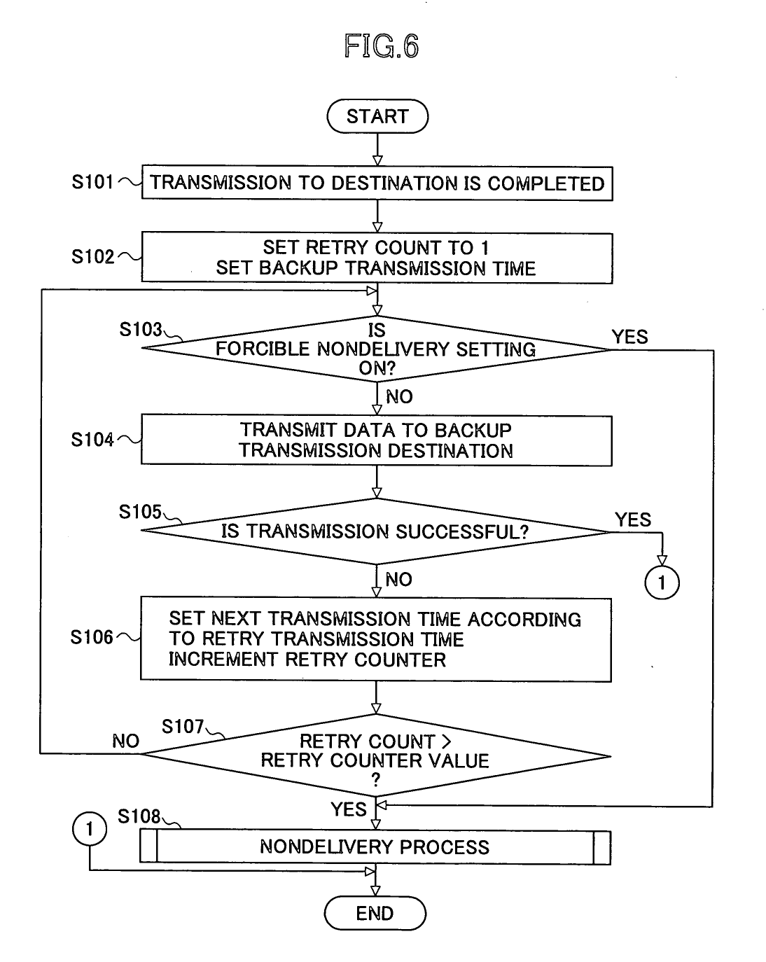

FIGS. 1 through 7 show an embodiment of the image processing apparatus according to the present invention, and FIG. 1 is a drawing showing the configuration of the main block of a facsimile apparatus 1 which is an application of an embodiment of the image processing apparatus according to the present invention.

The facsimile apparatus 1 shown in FIG. 1 includes a FAX control unit 2, an operations unit 3, a display unit 4, a scanning unit 5, a recording unit 6, a signal-generating unit 7, a memory 8, a line control unit 9, and a network control unit 10.

The FAX control unit 2 may include a central processing unit (CPU), a read only memory (ROM), and a random access memory (RAM). The ROM stores various programs such as a basic processing program for the facsimile apparatus 1 and a backup transmission control processing program discussed below, and various data and system data required to run the basic processing program and the backup transmission control processing program. In the FAX control unit 2, the CPU uses the RAM as a working memory to control other units in the facsimile apparatus 1, to perform basic processing of the facsimile apparatus 1, and to perform the backup transmission control processing discussed below, according to the programs in the ROM.

The operations unit 3 (a setting unit and a selecting unit) includes various operation keys such as a numeric keypad, a start key, function keys, and one-touch keys. These operation keys are used to enter various instructions such as those for transmission operation. The operations unit 3 is used particularly to set the retry transmission conditions for the backup transmission of faxed image data discussed below and to select a method from plural reporting methods used when all retry transmissions fail.

The FAX control unit 2 receives various operating instructions from the operations unit 3 and performs the processing according to the operating instructions.

For the display unit 4, a liquid crystal display (LCD) may be used. The display unit 4 is controlled by the FAX control unit 2 and displays various information items which will be reported by the facsimile apparatus 1 to the operator, especially instructions from the operation keys and various information items which will be reported to the operator during the backup transmission control processing, including the result of a backup transmission such as a message reporting the failure of the backup transmission.

For the scanning unit 5, a line image scanner incorporating a charge coupled device (CCD) may be used. The scanning unit 5 scans a document, reads the image of the document at a specified resolution, and outputs the image data.

For the recording unit 6, an electrophotographic recording apparatus or an ink jet recording apparatus may be used. The recording unit 6 prints on recording paper an image received or scanned by the scanning unit 5, a transmission report, or the result of a backup transmission.

For the memory 8 (an image storage unit and a storage unit), a battery backed-up RAM or a hard disk is used. The memory 8 temporarily stores image data which are scanned by the scanning unit 5 for transmission and stores various information items used in the facsimile apparatus 1, and in particular, various information items used in the backup transmission control processing.

The signal-generating unit 7 converts image data for transmission in the memory 8 into a special transmission format.

The line control unit 9 is connected to a line such as a public telephone line and operates under the control of the FAX control unit 2. The line control unit 9, via the line, acquires lines, transmits selection signals which represent destination telephone numbers, detects incoming calls, and automatically answers call requests from the line. Also, the line control unit 9 performs automatic call processing for the line and performs facsimile transmission procedures by exchanging facsimile control signals with a destination facsimile apparatus.

The network control unit 10 is connected to a network such as a local area network (LAN) which is connected to a dedicated server for storing faxed image data. The network control unit 10 makes a connection with the server via the network and performs the backup transmission of faxed image data. The network control unit 10 also retrieves backed-up data saved in the server.

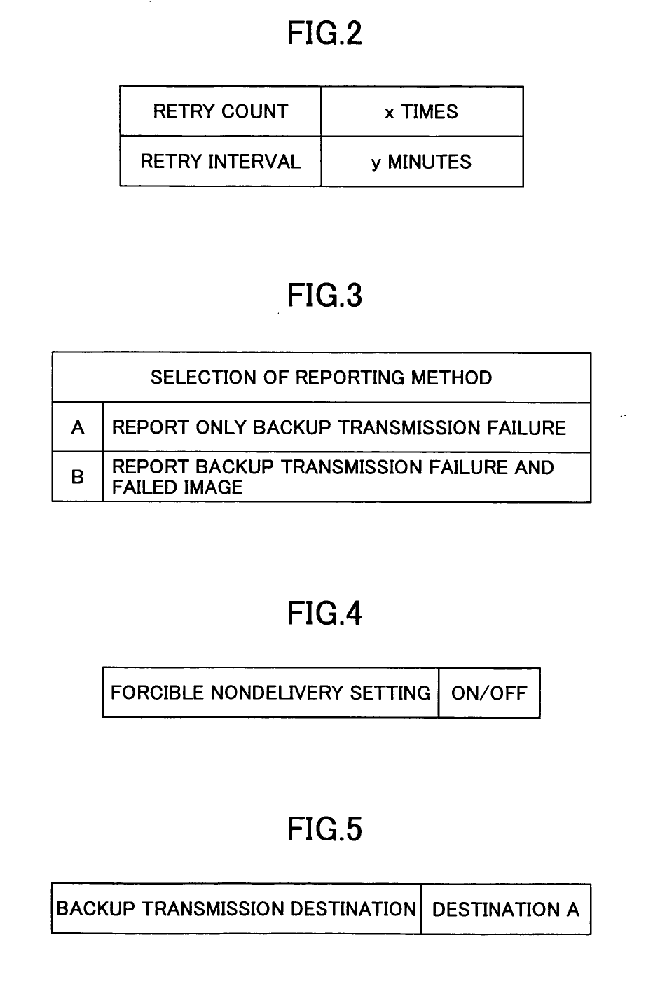

The facsimile apparatus 1 performs the backup transmission processing in which faxed image data (processed image data) are transmitted for backup to the server on the network connected to the network control unit 10. When the backup transmission fails, the facsimile apparatus 1 retries the backup transmission of the faxed image data according to the preset backup transmission retry conditions (retry conditions). The backup transmission retry conditions may consist of the retry count and the retry interval as shown in FIG. 2, and the user can set the conditions as he/she wishes by operating the keys in the operations unit 3 (a setting unit). The FAX control unit 2 stores the backup transmission retry conditions set by using the operations unit 3 in the memory 8. The memory 8 should preferably be a nonvolatile memory or a battery backed-up memory so that the memory content can be retained in case of a blackout. The retry count and the retry interval in the retry conditions should be set so as not to affect the network traffic of the installation environment, and the retry count should be appropriate as a retry condition to be used when the backup transmission fails.

The facsimile apparatus 1 reports the failure of the backup transmission to the administrator of the facsimile apparatus 1. The reporting method can be selected by operating the keys in the operations unit 3 (a selecting unit). For example, as shown in FIG. 3, the reporting method can be selected from two methods: the reporting method A which reports only the backup transmission failure based on the prepared message in the memory 8, and the reporting method B which reports the backup transmission failure and the failed image. The FAX control unit 2 stores the reporting method selected by using the operations unit 3 in the memory 8.

When a job involving storage of data into the memory 8 (hereafter called a job), such as storing image data of another document or receiving incoming data, is initiated during the backup transmission or the backup retry transmission, the facsimile apparatus 1 improves the availability by giving the priority to the job over the backup transmission or the backup retry transmission. If the capacity of the memory 8 runs short (hereafter called memory shortage) when such a job is initiated during the backup transmission or the backup retry transmission, the facsimile apparatus 1 cancels the current backup transmission or backup retry transmission and deletes the image data which are the object of the backup transmission or the backup retry transmission from the memory 8, thereby creating a space in the memory 8 for the new job so as to perform the job as the first priority.

When such memory shortage occurs, the FAX control unit 2 sets the ON/OFF of the forcible nondelivery setting in the memory 8 shown in FIG. 4 to ON, forcibly cancels the backup transmission or the backup retry transmission, and forcibly reports the backup transmission failure (performs the forcible nondelivery reporting).

In the facsimile apparatus 1, the backup transmission destination information, for example “Destination A” as shown in FIG. 5, is stored in the memory 8, and the backup transmission is directed only to the destination. The backup transmission destination may be, but is not limited to, a server on the network connected to the network control unit 10. The backup transmission destination may also be a facsimile apparatus used as a server on the line connected to the line control unit 9.

Next, the flow of the process in this embodiment is described. The facsimile apparatus 1 in this embodiment backs up faxed image data by transmitting the data to the server specified as the backup transmission destination. If the backup transmission fails, the facsimile apparatus 1 retries the backup transmission of the faxed image data according to the specified backup transmission retry conditions.

In the facsimile apparatus 1, when the facsimile transmission is completed successfully (step S101), the FAX control unit 2 sets the retry count to 1 and sets the backup transmission time by retrieving the information from the memory 8 (step S102).

The FAX control unit 2 then checks the forcible nondelivery setting in the memory 8 to see if the setting is set to ON (step S103). When the forcible nondelivery setting is set to OFF, the FAX control unit 2 decides that there is no memory shortage and starts the backup transmission of the faxed data to the backup transmission destination stored in the memory 8 (step S104).

The FAX control unit 2 determines whether the started backup transmission has ended successfully (step 105). If the backup transmission has been successful, the FAX control unit 2 terminates the entire process since the backup retry transmission is not required.

In step S105, if the transmission has not been successful, the FAX control unit 2 sets the next transmission time (setting of the next transmission time) according to the retry transmission time set in step S102, increments the retry counter by 1 (incrementing of the retry counter) (step S106), and determines whether the retry counter value exceeds the retry count set in step S102 (step S107).

If the retry counter value is not greater than the retry count in step S107, the FAX control unit 2 returns to step S103 and repeats the same steps (steps S103 to S107) beginning with checking the forcible nondelivery setting. If the retry counter value is greater than the retry count in step S107, the FAX control unit 2 performs the nondelivery process and terminates the entire process (step S108).

In step S103 in the above process, when the forcible nondelivery setting is ON, the FAX control unit 2 determines that there is a memory shortage, cancels the backup transmission, performs the nondelivery process, and terminates the entire process (step S108).

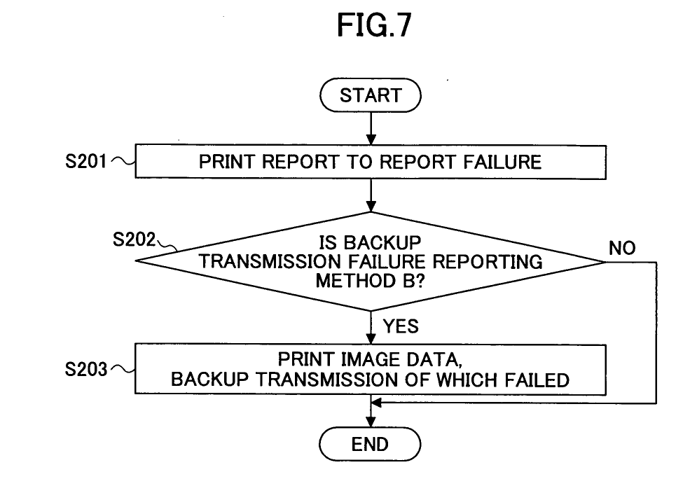

Next, the nondelivery process in step S108 is described based on FIG. 7. In the nondelivery process, the FAX control unit 2 first generates a nondelivery report which reports the failure of the backup transmission or the backup retry transmission, instructs the recording unit 6 to print the report on recording paper (step S201), and then determines whether the reporting method B which reports the backup transmission failure and the failed image is selected as the backup transmission failure reporting method (step S202).

In step S202, if the reporting method A which reports only the backup transmission failure is selected as the backup transmission failure reporting method, the FAX control unit 2 terminates the entire process since the nondelivery report has already been printed in step S201.

In step S202, if the reporting method B which reports the backup transmission failure and the failed image is selected as the backup transmission failure reporting method, the FAX control unit 2 retrieves the image data the backup transmission of which failed from the memory 8, instructs the recording unit 6 to print the image on recording paper, and terminates the entire process (step S203).

As described above, if the backup transmission of the faxed image data in the memory 8 to the specified server fails, the facsimile apparatus 1 in this embodiment retries the transmission of the faxed image data according to the specified retry condition.

This mechanism enables retry transmissions of faxed image data according to the retry conditions that suit the environment where the facsimile apparatus 1 is used, providing more reliable backups of faxed image data and improving the availability.

If the retry transmission fails, the facsimile apparatus 1 in this embodiment reports the backup failure using the reporting method selected from two methods: the reporting method A which reports only the backup transmission failure, and the reporting method B which reports the backup transmission failure and the failed image.

These reporting methods enable the user to learn of the backup transmission failure in an appropriate and reliable manner that the user selects.

When an operation (a job) which involves storage of data into the memory 8, such as storing image data of another document or receiving incoming data, is initiated during the backup transmission or the backup retry transmission, and memory shortage in memory 8 occurs, the facsimile apparatus 1 in this embodiment cancels the current backup transmission or backup retry transmission and deletes the image data which are the object of the backup transmission or the backup retry transmission from the memory 8, and reports the backup transmission failure using the specified reporting method.

The facsimile apparatus 1 creates a space in the memory 8 for the new job so as to perform the job as the first priority and reports the backup failure, thereby improving the availability of the facsimile apparatus 1.

In the embodiment described above, the facsimile apparatus 1 is used as an example of an image processing apparatus, and facsimile transmission is used as an example of image processing. However, the present invention can be applied not only to facsimile apparatuses but also to any other image processing apparatuses such as personal computers, scanners, and copiers. Also, the present invention can be applied not only to facsimile transmission but also to any other image processing such as image scanning, image editing, and image data transmission.

In the above description, the present invention of the inventor is explained in detail based on a preferred embodiment. However, the present invention is not limited to the embodiment described above, and various modifications may be made without departing from the scope of the present invention.

The present invention can be applied to any image processing apparatus which requires backup transmission of image data that has gone through image processing such as facsimile transmission.

The present application is based on Japanese Priority Application No. 2005-148980, filed on May 23, 2005, the entire contents of which are hereby incorporated herein by reference.

What is claimed is:

1. An image processing apparatus in which image data are stored in an image storage unit, the image data in the image storage unit are transmitted to a specified server for backup when processing of the image data is completed successfully, and the processed image data in the image storage unit are deleted when the backup transmission is completed successfully, the apparatus comprising:
a setting unit for setting conditions for retrying the backup transmission; wherein
the retry transmission of the processed image data is performed according to the retry conditions set by the setting unit when the backup transmission of the processed image data fails.

2. The image processing apparatus as claimed in claim 1, further comprising:
a memory unit which stores a plurality of methods for reporting failure of all retry transmissions specified by the retry conditions; and
a selecting unit for selecting one of the reporting methods in the memory unit; wherein
a backup failure reporting process that reports backup failure is performed using the reporting method selected by the selecting unit.

3. The image processing apparatus as claimed in claim 2, wherein if capacity of the image storage unit runs short because a new job involving storage of image data into the image storage unit is generated during the backup transmission or retry transmission of the processed image data in the image storage unit, the backup transmission or the retry transmission is cancelled, the processed image data are deleted from the image storage unit, and the backup failure reporting process is performed.
